(19) United States
(12) Patent Application Publication
(10) Pub. No.: US 2006/0170676 A1
(43) Pub. Date: Aug. 3, 2006

(54) Representing a 3D object with a PDE surface patch

(76) Inventor: Hassan Ugail, Bradford (GB)

Correspondence Address: ADAMS EVANS P.A., 2180 TWO WACHOVIA CENTER, CHARLOTTE, NC, 28282, US

(21) Appl. No.: 11/071,936

(22) Filed: Mar. 4, 2005

(30) Foreign Application Priority Data
Feb. 1, 2005 (GB) GB 0502022.9

(51) Int. Cl. G06T 15/40

(52) U.S. Cl. 345/421

(57) ABSTRACT

A set of control curves P₁, P₂, D₁, D₂ act as boundary conditions to a partial differential equation (PDE) which when solved provides a PDE surface patch of a 3D object. Also, a spine S is provided which allows coordinated manipulation of the control curves. The spine S is ideally derived as part of the solution to the partial differential equation. Altering the shape or position of the spine S automatically alters the shape or position of the control curves, such that manipulation of the PDE surface patch then becomes much easier.

### TECHNICAL FIELD AND BACKGROUND OF THE INVENTION

The present invention relates in general to a method and apparatus to represent a 3D object. In particular, the present invention relates to a method and apparatus to represent a surface of an object using a partial differential equation (PDE) surface patch.

### DESCRIPTION OF THE RELATED ART

Computer Aided Design (CAD) is just one example of an environment where there is a strong need to represent 3D objects. Such CAD systems allow a designer to view an image of the object, and perform functions such as manipulating the shape of the object. It is important for computer aided design systems to be able to define and represent the shapes of complex objects with ease. Also, it is desired to allow shape manipulation to be performed accurately, efficiently and intuitively.

Most currently available commercial CAD systems employ polynomial surface modelling schemes, such as Non-Uniform Rational B-Splines (NURBS). NURBS are based on simple polynomial functions associated with control points including weights and knots. An intuitive and predictable manipulation of surface shape is possible for simple shapes by changing the position of the control points. However, as the object becomes more complex, the process of shape manipulation becomes increasingly time consuming and rather non-intuitive. In particular, movement of a control point has only limited relation to changes in the shape of the object, and it becomes increasingly difficult for the designer to accurately and efficiently manipulate the shape of the object.

A paper by Ugail H., Bloor, M. I. G., Wilson M. J.: TECHNIQUES FOR INTERACTIVE DESIGN USING THE PDE METHOD, ACM Transactions on Graphics, Vol. 18, No. 2, pp195-212 (dated 2 Apr. 1999), by the present inventor and others, discusses a shape modelling technique using a partial differential equation (PDE) to describe the shape of a surface of an object. This is conveniently known as a PDE surface or a PDE surface patch.

Partial differential equations are themselves ubiquitous in science and are used to describe various different phenomena such as fluid flow, gravitational fields or electromagnetic fields. PDEs are useful in areas such as aircraft flight simulation and weather prediction, as well as theoretical explanations for general relativity and quantum mechanics. However, the use of PDEs to represent the shape of the surface of a 3D object is a relatively new and unexplored field, and is a substantial departure from traditional modelling techniques.

A PDE surface is defined by boundary conditions, suitably in the form of a plurality of boundary curves. A complex surface shape is created by mathematically solving the PDE for those boundary conditions. In a CAD system or other graphics tool, controlling the shape and position of the boundary curves thereby creates and manipulates the surface shape of the 3D object.

A problem has now been identified in that the process of shape manipulation is sometimes time-consuming, inaccurate and unpredictable, even when representing objects with PDE surfaces. In particular, where complex objects are built from a plurality of PDE surface patches, it becomes difficult to accurately alter or reposition the boundary curves to achieve a desired manipulation of the surface of the 3D object.

### SUMMARY OF THE INVENTION

An aim of the present invention is to address the problems of the prior art, as expressed above or otherwise.

A preferred aim of the present invention is to provide a method and apparatus to represent a 3D object with a PDE surface, in which manipulation is accurate and predictable.

According to the present invention there is provided an apparatus and method as set forth in the appended claims. Preferred features of the invention will be apparent from the dependent claims, and the description which follows.

In one aspect of the present invention, a set of control curves act as boundary conditions to a partial differential equation (PDE) which when solved provides a PDE surface patch of a 3D object. Also, a spine is provided which provides coordinated manipulation of the control curves. Altering the shape or position of the spine automatically alters the shape or position of the control curves, and ideally vice versa, such that manipulation of the PDE surface patch then becomes much easier. Accuracy and predictability are improved. Also, in the preferred embodiments, a more intuitive user interface is achieved.

In a preferred embodiment, the spine is derived as part of the solution to the partial differential equation. This way, the spine is obtained with no additional computational effort.

### BRIEF DESCRIPTION OF THE DRAWINGS

For a better understanding of the invention, and to show how embodiments of the same may be carried into effect, reference will now be made, by way of example, to the accompanying diagrammatic drawings in which:

FIG. 1 shows an example three-dimensional object;

FIGS. 2a and 2b show a second example 3D object;

FIGS. 3a, 3b and 3c show PDE control curves of a third example object;

FIGS. 4a and 4b show another example object and corresponding spine or spines for each PDE surface patch;

FIGS. 5a and 5b show another example object and corresponding spine or spines for each PDE surface patch;

FIG. 6 shows an example of manipulation of PDE control curves using a spine;

FIG. 7 is an overview of a preferred method of representing a 3D object using a PDE surface patch;

FIGS. 8a and 8b illustrate manipulation using shape parameters defined on a spine;

FIGS. 9a and 9b show another example of shape manipulation using a spine;

FIG. 10 shows an example apparatus as employed in preferred embodiments of the present invention;

FIG. 11 shows an example data storage format to represent a 3D object;

FIGS. 12 and 13 show an example of curve data in a preferred data storage format; and

FIG. 14 illustrates a further example of a preferred data storage format.

In the drawings, like reference numerals are used to denote like elements.

### DETAILED DESCRIPTION OF THE PREFERRED EMBODIMENT AND BEST MODE

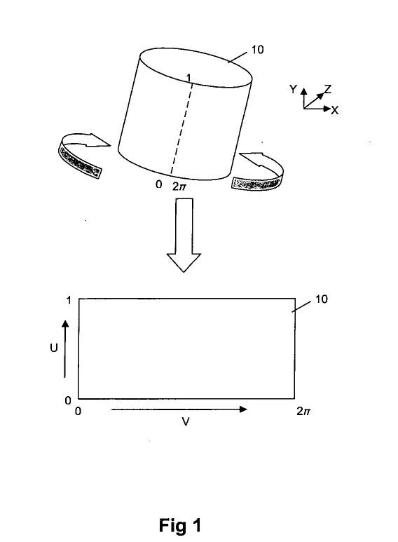

FIG. 1 shows an example three-dimensional object 10. In this case, the object is a simple cylinder. In most three-dimensional graphical representations or 3D modelling systems, the object 10 is considered in terms of orthogonal X, Y and Z axes as shown in FIG. 1. On a 2D display surface such as a page of paper or a computer screen, the Z axis is conveniently aligned to be perpendicular to the plane of the display.

A PDE surface patch represents the surface of the object 10 by in effect transforming from measurements in the X, Y, Z directions in FIG. 1 to instead represent the object in a parametric region defined by two parameters u and v such that any point on the surface X is given by an expression of the form,
X(u,v)=(x(u,v),y(u,v),z(u,v)) (1)

To illustrate this alternate approach of PDE surfaces, one can consider that the cylinder 10 has been cut open along its length and laid out flat. The shape of the surface is then defined in relation to the u,v space.

In more detail, a PDE surface is a parametric surface patch X(u,v), defined as a function of two parameters u and v on a finite domain Ω⊂R², by specifying boundary data around the edge region of ∂Ω. Typically the boundary data are specified in the form of X(u,v) and a number of its derivatives on ∂Ω. Moreover, this approach regards the coordinates of the (u,v) point as a mapping from that point in Ω to a point in the physical space. To satisfy these requirements the surface X(u,v) is regarded as a solution of a PDE based on the elliptic bi-harmonic equation ∇⁴=0, namely

$${( \frac{{\partial }^{2}}{\partial {u}^{2}} + {a}^{2} \frac{{\partial }^{2}}{\partial {v}^{2}} )}^{2} \underline{X} ( u , v ) = 0. \qquad ( 2 )$$

Here the boundary conditions on the function X(u,v) and its normal derivatives ∂X/∂n are imposed at the edges of the surface patch.

Equation (2) is a second-order equation. In other embodiments of the invention, third or even higher order PDEs are employed. However, for ease of illustration, the bi-harmonic form of PDE is discussed herein.

The parameter a in Equation (2) is an optional special design parameter employed in preferred embodiments of the present invention to control the relative smoothing of the surface in the u and v directions. That is, the parameter a produces a waist effect within the interior of the surface patch, with higher values of a producing a more pronounced waist effect. The parameter a is particularly useful when designing objects with an interactive graphical design tool (e.g. a CAD system).

There exist many methods to determine the solution of Equation (2) ranging from analytic solution techniques to sophisticated numerical methods. For the work described here restricting to periodic boundary conditions, a closed form analytic solution of Equation (2) is utilised.

Choosing the parametric region to be 0≦u≦1 and 0≦v≦2π, the periodic boundary conditions can be expressed as X(0,v)=P₁(v), X(1,v)=P₂(v), Xᵤ(0,v)=d1(v), and X(1,v)=d₂(v).

The boundary conditions P₁(v) and P₂(v) define the edges of the surface patch at u=0 and u=1 respectively. Using the method of separation of variables, the analytic solution of Equation (2) can be written as:

$$\begin{matrix}\underline{X} ( u , v ) = {\underline{A}}_{0} ( u ) + {\sum }_{n = 1}^{∞} [ {\underline{A}}_{n} ( u ) cos ( nv ) + {\underline{B}}_{n} ( u ) sin ( nv ) ] , \\ where & ( 3 ) \\ {\underline{A}}_{0} ( u ) = {\underline{a}}_{00} + {\underline{a}}_{01} u + {\underline{a}}_{02} {u}^{2} + {\underline{a}}_{03} {u}^{3} , & ( 4 ) \\ {\underline{A}}_{n} ( u ) = {\underline{a}}_{n 1} {ⅇ}^{anu} + {\underline{a}}_{n 2} {uⅇ}^{anu} + {\underline{a}}_{n 3} {ⅇ}^{- anu} + {\underline{a}}_{n 4} {uⅇ}^{- anu} , & ( 5 ) \\ {\underline{B}}_{n} ( u ) = {\underline{b}}_{n 1} {ⅇ}^{anu} + {\underline{b}}_{n 2} {uⅇ}^{anu} + {\underline{b}}_{n 3} {ⅇ}^{- anu} + {\underline{b}}_{n 4} {uⅇ}^{- anu} , & ( 6 )\end{matrix}$$

where a₀₀,a₀₁,a₀₂,a₀₃,aₙ₁,aₙ₂,aₙ₃,aₙ₄,bₙ₁,bₙ₂,bₙ₃ and bₙ₄ are vector constants, whose values are determined by the imposed boundary conditions at u=0 and u=1.

For a general set of boundary conditions, in order to define the various constants in the solution, it is appropriate to Fourier analyse the boundary conditions and identify the various Fourier coefficients. Where the boundary conditions can be expressed exactly in terms of a finite Fourier series, the solution given in Equation (3) will also be finite. However, this is often not possible, in which case the solution will be the infinite series given Equation (3).

The preferred technique for finding an approximation to X(u,v) is based on the sum of the first few Fourier modes and a “remainder term”, i.e.,

$$\underline{X} ( u , v ) \approx {\underline{A}}_{0} ( u ) + {\sum }_{n = 1}^{N} [ {\underline{A}}_{n} ( u ) cos ( nv ) + {\underline{B}}_{n} ( u ) sin ( nv ) ] + \underline{R} ( u , v ) , \qquad ( 7 )$$

where N is usually small (e.g. N<10) and R(u,v) is a remainder function defined as,
R(u,v)=r₁(v)e^{wu}+r₂₍ᵥ₎ₑ^{wu}+r₃(v)e^{-wu}+r₄₍v)e^{-wu}, (8)
where r₁,r₂,r₃,r₄ and w are obtained by considering the difference between the original boundary conditions and the boundary conditions satisfied by the function

$$\underline{F} ( u , v ) = {\underline{A}}_{0} ( u ) + {\sum }_{n = 1}^{N} [ {\underline{A}}_{n} ( u ) cos ( nv ) + {\underline{B}}_{n} ( u ) sin ( nv ) ] , \qquad ( 9 )$$

Although the solution is approximate, this preferred solution technique guarantees that the chosen boundary conditions are exactly satisfied since the remainder function R(u,v) is calculated by means of the difference between the original boundary conditions and the boundary conditions satisfied by the function F(u,v).

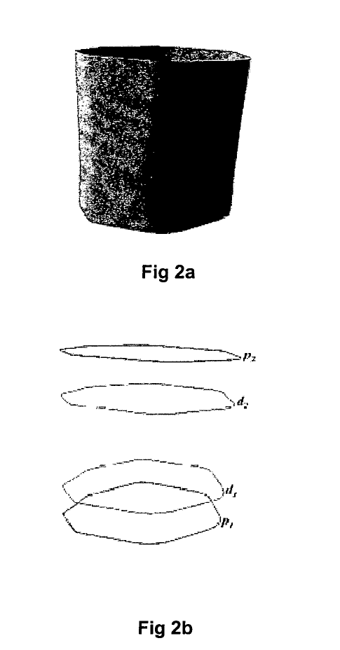

FIGS. 2a and 2b show a second example 3D object.

As shown in FIG. 2a, in this second example the object 10 is generally heptagonal in cross-section but with complex variations in shape along its length. Despite the complex shape, the PDE surface is controlled by just by the control curves P₁,P_{2 and d}₁,d₂ as shown in FIG. 2b. These control curves may be open curves, or may be closed loops as in this example. The control curves may have a complex form, including sharp corners.

The curves correspond to the boundary conditions on the function X(u,v), where P₁(v)=X(0,v) and P₂(v)=X(1,v). A vector field corresponding to the difference between the points on the curves P₁ and P₂ and d₁ and d₂ respectively, corresponds to the conditions on the function ∂X/∂n such that ∂X/∂n=[p(v)−d(v)]s, where s is a scalar. That is, the size and relative distance between the position curves P₁, P₂ and the derivative curves d₁, d₂ defines the direction that the surface will propagate along the object.

It can be appreciated that, from a design point of view, this boundary curve based approach is a user-friendly tool for PDE surface manipulation in an interactive environment. The initial set of control curves are readily created such as by a designer freely drawing the curves with an appropriate user input device or with click and drag operations. Further, the designer can readily manipulate the shape of the object shown in FIG. 2a simply by changing the shape and/or position of the control curves P₁, P₂ and d₁, d₂ of FIG. 2b. For example, the designer operates the system to toggle between two display modes of FIGS. 2a and 2b, or else the control curves are overlaid onto the resultant PDE surface. Manipulation of these boundary curves of a PDE surface is far simpler than other approaches to graphical modelling such as NURBS.

Whilst the control curves of FIG. 2a are simple and intuitive to create and to manipulate, in some circumstances it can become tedious for the designer to accurately shape and position each of the control curves, especially in a more complex object comprising many individual PDE surface patches.

Spine

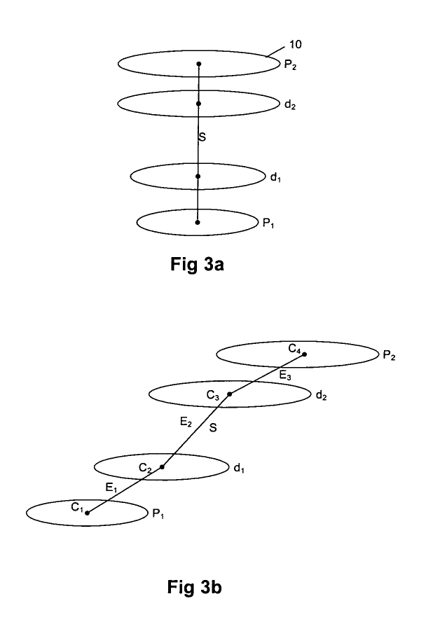

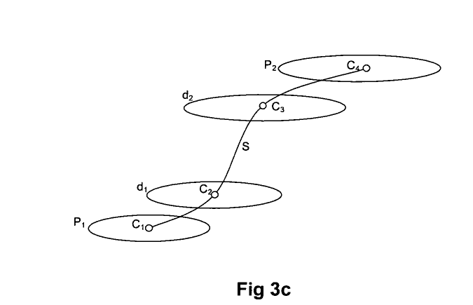

FIGS. 3a, 3b and 3c show PDE control curves of a third example object. Here, the preferred embodiments of the present invention also provide a spine S which links each of the control curves P₁,P₂ and d₁,d₂. The spine S can take many different forms.

As shown in FIG. 3a, in a first embodiment the spine S is a single straight line which intersects two or more control points associated with the control curves P₁, P₂ and d₁, d₂. In this example the control curves P₁, P₂, d₁, d₂ are each plane curves and the control points C₁, C₂, C₃, C₄ each lie in the plane of a respective control curve.

As shown in FIG. 3b, in a second embodiment the spine S comprises a set of straight lines as rigging between the control curves. That is, the spine S comprises first, second and third spine elements E₁, E₂, E₃ (i.e. vertebrae) each being a straight line between fixed points associated with two adjacent control curves. A plurality of spine control points C₁, C₂, C₃, C₄ are determined, conveniently each being a centroid in the plane of the respective control curve. The spine elements E₁, E₂, E₃ are conveniently each fixed length lines between the control points C₁, C₂, C₃, C₄.

As shown in FIG. 3c, in another preferred embodiment the spine S is a curve linking a set of predetermined control points in the plane of each of the control curves. That is, the spine S is a curve fitted to the spine control points C1,C2,C3,C4 from each of the control curves. For example, the spine is a Bezier curve or a B-Spline.

Spine Derivation

The preferred embodiment of the present invention derives the spine S as part of the solution of the partial differential equation defining the PDE surface. The spine S is extracted as a by-product of the solution and requires no additional computation.

Firstly, it has been identified that the term A₀ in Equation (3) is a cubic polynomial of the parameter u. Secondly it can be seen that for each point X(u,v) on the PDE surface the term

$${\sum }_{n = 1}^{∞} [ {\underline{A}}_{n} ( u ) cos ( nv ) + {\underline{B}}_{n} ( u ) sin ( nv ) ]$$

in Equation (3) describes the radial position of the point X(u,v) away from a point at A₀. Finally, applying the triangle inequality of Equation (3), one can see that,

$$‖ {\underline{A}}_{0} ( u ) ‖ \leq ‖ \underline{X} ( u , v ) ‖ + ‖ {\sum }_{n = 1}^{∞} [ {\underline{A}}_{n} ( u ) cos ( nv ) + {\underline{B}}_{n} ( u ) sin ( nv ) ] ‖ . \qquad ( 10 )$$

Thus, the term A₀ which is a cubic polynomial of the parameter u traces out a curve in 3-space which follows the “centreline” of the surface patch. Therefore, using the solution technique described above for Equation (3), a surface point X(u,v) may be regarded as being composed of sum of a vector A₀ giving the position on the spine of the surface and a radius vector defined by the term

$${\sum }_{n = 1}^{∞} [ {\underline{A}}_{n} ( u ) cos ( nv ) + {\underline{B}}_{n} ( u ) sin ( nv ) ]$$

providing the position of X(u,v) relative to the spine S. More precisely, for a PDE surface described by the Equation (3), the spine is constructed by taking that part of the solution with zero mean by way of removing the periodic contribution.

It is noteworthy that the introduction of the R(u,v) term in the preferred solution described in Equation (7) hardly affects the interior shape of the surface. This is due to the fact that for larger n the Fourier modes make negligible contributions to the interior of the patch. Therefore, as far as the spine S of the shape generated using Equation (7) is concerned, since the spine does not represent the detailed geometry of the shape, the A₀(u) term is left unchanged by the introduction of the R(u,v) term in the approximate solution and hence the spine of the shape is left unchanged.

Although the particular definition for the spine of a PDE surface that is adopted here is very convenient from the point of view of the underlying mathematical representation of the surface, it is by no means a unique definition and alternative solutions are also applicable to the present invention.

As one alternative example, the spine is calculated as a centroid of the respective control curve. That is, the curve is taken to define the outline of a lamina having an equally distributed mass, and the centroid is calculated as the centre of gravity of the lamina. Hence, the spine has a predetermined association with the set of control curves. This associated is either set such as by a centre of gravity of each control curve, or, as in the preferred embodiment, is derived from solving the partial differential equation.

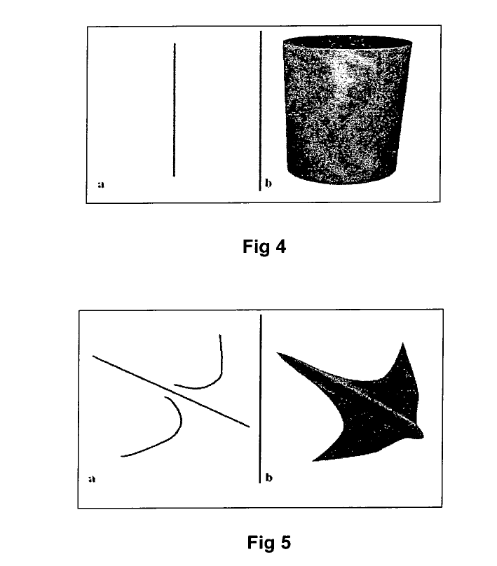

FIGS. 4a and 4b and FIGS. 5a and 5b show further example objects and their corresponding spine or spines for each PDE surface patch.

FIG. 4b shows an example PDE surface of generally cylindrical form. This particular shape is created by means of four appropriately spaced ellipses defining the boundary conditions P₀(v), P₁(v), d₀(v) and d₁(v). FIG. 4a shows the image of the cubic polynomial described by the A₀ term corresponding to the spine S of this surface patch.

FIG. 5b shows a composite shape that generally resembles the outline shape of an aircraft. This shape is created by combining a plurality of surface patches. In this example, five surface patches (one for the fuselage and two for each wing) are used, with common boundaries where necessary. The corresponding composite spine for the aircraft shape is shown in FIG. 5a. As can be noted, in both these examples the spine closely describes the centreline of the object.

In some embodiments of the present invention, it is appropriate to create a new object by first drawing or defining the spine S, and then placing a plurality of control curves P₁,P₂,d₁,d₂ in relation to the spine. Alternatively, as described above for the preferred embodiments of the present invention, the boundary curves P₁,P₂,d₁,d₂ are defined first, and then the spine derived automatically as the A₀ term in the solution of Equation 3.

Shape Manipulation

One of the many attractive features of PDE surfaces is their ability to be able to create and manipulate complex shapes with ease. A user with little or no knowledge of solving PDEs and how the boundary conditions affect the solutions of the PDEs is able to use the method to create complex geometry with ease. The shapes in this case are parameterised using the boundary curves that define them. However, in order to manipulate the shape of very complex objects, the number of curve manipulations can be excessive. Since the spine S of the PDE surface characterises the surface patch as a whole, rather than individual boundaries, a shape parameterisation based on the spine provides further intuitive tools for shape manipulation.

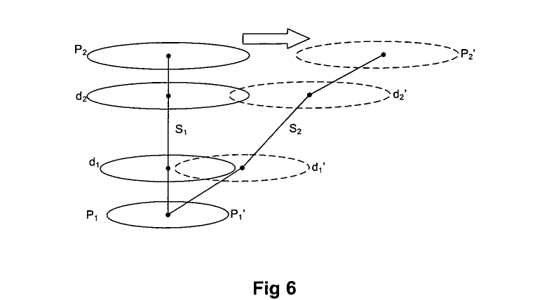

FIG. 6 shows an example of manipulation of the control curves P₁,P₂ and d₁,d₂ using the spine S.

Preferably, the spine S is output to a display. Conveniently the spine S is displayed along with the control curves P₁,P₂ and d₁,d₂. The system then has the option of manipulating the curves using the spine S. As shown in FIG. 6, a lateral transition of the curves is readily achieved simply by moving one end of the spine S, such as with a click and drag operation. The control curves P₁,P₂ and d₁,d₂ have a predetermined fixed relation with the spine S, and hence the control curves are moved to a new shape by manipulation of the spine S.

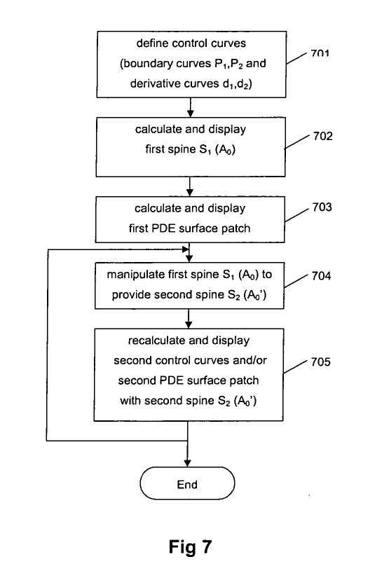

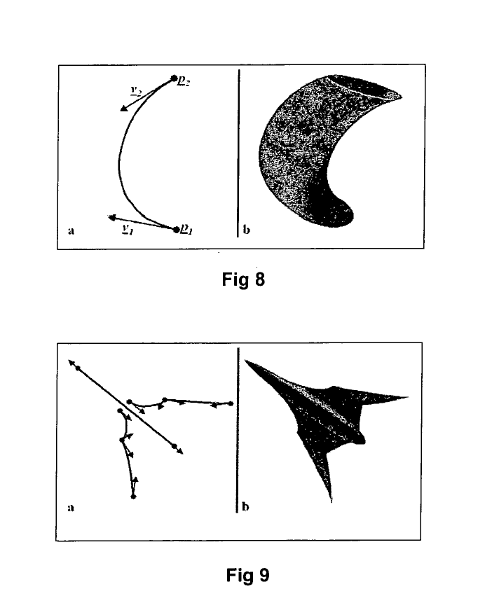

Referring to FIG. 6, manipulation of the spine from position S₁ to new a position S₂ causes a corresponding adjustment of the control curves P₁,P₂,d₁,d₂ to a new arrangement here shown as curves P₁′,P₂′,d₁′,d₂′. This manipulation operation will now be described in more detail with reference to FIGS. 7, 8 & 9.

FIG. 7 is an overview of a preferred method of representing a 3D object using a PDE surface patch.

Step 701 comprises defining boundary conditions of the PDE, in this case by creating a plurality of control curves. In the preferred embodiment the control curves include boundary curves P₁, P₂ and corresponding derivative curves d₁, d₂.

At step 702, a first spine S1 is calculated from the control curves. Suitably the first spine S1 is displayed along with the first set of control curves.

At step 703, optionally a PDE surface patch is calculated and displayed, as defined by the first set of boundary curves P₁, P₂ and d₁, d₂ and the first spine S1. Alternatively, the system may work simply with the boundary curves and spine, without resolving the PDE surface patch at this stage.

At step 704, the first spine S1 is manipulated to provide a new second spine S2. For example, the system provides an interface for a designer to click and drag one end of the spine to a desired new position.

At step 705, the new spine S2 is used to provide a second set of control curves P₁′, P₂′ and d₁′, d₂′. In the preferred embodiment, the spine S2 defines an updated term A₀′ which is used to recalculate the solution of the partial differential equation and provide the update second set of control curves. Optionally, the new position of the spine S2 and the updated control curves are displayed. Also, optionally the new shape of the PDE surface patch is calculated and displayed.

With this iterative process, iterative adjustments can be made to the spine with corresponding recalculations of the control curves in the PDE surface patch, until a satisfactory result is achieved. That is, the spine Sⁿ and the corresponding control curves P₁ⁿ, P₂ⁿ and d₁ⁿ, d₂ⁿ are adjusted by spine Sⁿ⁺¹ to give the resultant updated control curves P₁ⁿ⁺¹, P₂ⁿ⁺¹ and d₁ⁿ⁺¹, d₂ⁿ⁺¹.

Conversely, adjusting any one or more of the control curves p₁ⁿ, P₂ⁿ and d₁ⁿ, d₂ⁿ to provided updated control curves p₁ⁿ⁺¹, P₂ⁿ⁺¹ and d₁ⁿ⁺¹, d₂ⁿ⁺¹ results in a corresponding change to the shape of the spine from Sⁿ to Sⁿ⁺¹.

That is, in some instances it is appropriate to adjust the spine to manipulate the object. In other circumstances it is preferable to alter one or more of the control curves to manipulate the object, and in doing so thereby also adjust the spine.

Spine Manipulation

As discussed above, manipulation of the spine S is a powerful and intuitive mechanism to manipulate the shape of a PDE surface. There are many ways in which the spine can be utilised in various different embodiments of the invention. A particularly preferred mechanism for defining and manipulating the spine S will now be described in more detail.

Preferably, the spine S is the cubic polynomial described by the A₀ term in Equation (3), and is considered to be a Hermite curve of the form
H(u)=B₁(u)p₁+B₂(u)p₂+B₃(u)v₁+B₄(u)v₂ (11)
where the Bᵢ are the Hermite basis functions, and the vectors P₁, P₂ and v₁,v₂ define the position and the speed of the Hermite curve at u=0 and u=1 respectively. By comparing the Hermite curve given in Equation (11) with the cubic for the spine S given as the A₀ term in Equation (3), the vector constants a₀₀, a₀₁, a₀₃ given in Equation (4) can be related to the position vectors and its derivatives at the end points of the spine S. Since the A₀ term in Equation (3) is an integral part of the preferred solution that generates the surface shape, any change in the shape of the spine S will have a resulting change in the shape of the surface.

A useful mechanism to change the shape of the spine S is to manipulate its position and the derivative at the two end points. Therefore, the position vectors and its derivatives at the end of points of the Hermite curve describing the spine are defined to be a new set of shape parameters that enable manipulation of the shape in an intuitive fashion.

To demonstrate this idea, consider the cylindrical shape shown in FIG. 4b where the corresponding spine S is also shown in FIG. 4a. FIG. 8b shows a resulting shape after some manipulation of the shape shown in FIG. 4b using the shape parameters defined on the spine S. FIG. 8a illustrates the resulting spine S and the parameters P₁,P₂ and v₁,y₂ for the resulting surface patch.

FIG. 9b shows another example of shape manipulation using the spine S. Here the shape of the aircraft shown in FIG. 5b was manipulated using the parameters defined on the composite spine shown in FIG. 5a. The final shape of the composite spine S and the parameters corresponding to the resulting shape of the aircraft are shown in FIG. 9a.

In both of these examples, the shape manipulations were carried out interactively via the position vectors P₁ and P₂ and the direction vectors v₁ and v₂, for each of the corresponding surface patches. The position vectors P₁ and P₂ are conveniently changed by means of clicking and dragging the points in 3-space. The direction vectors v₁ and v₂ are conveniently changed by changing the size and the direction of the arrows shown.

Apparatus and Data Storage

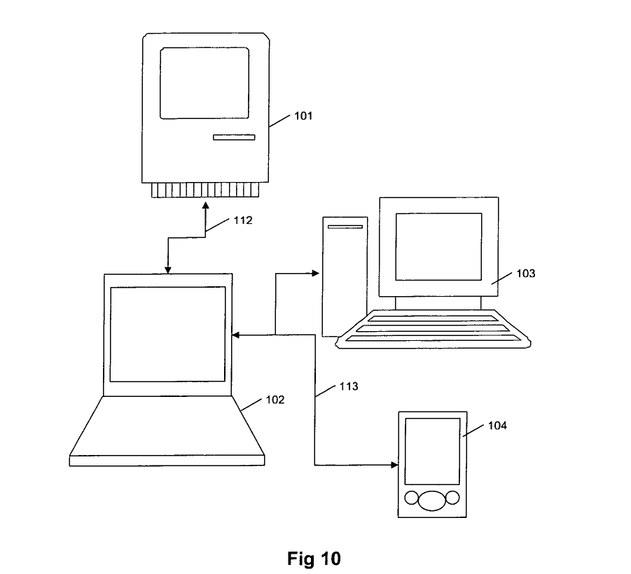

FIG. 10 shows an example apparatus as employed in preferred embodiments of the present invention.

As shown in FIG. 10, the preferred apparatus provides a computer-aided tool for design, modelling or manipulation of 3D objects. A display unit displays images to a user, and an input unit such as a keyboard, mouse, graphics pad or other suitable arrangement receives commands from the user, to create and manipulate the 3D object through the control curves and/or spine as discussed above. Further, the apparatus suitably comprises a processing unit to perform the manipulation and modelling techniques described herein.

The apparatus may be constructed from dedicated hardware, such as a dedicated graphics processor within a computer platform. Alternatively, the present invention is implemented as computer software running on a general purpose computer platform. Further, the present invention extends to a storage medium containing machine-readable instructions to perform the methods and tools described herein.

Referring again to FIG. 10, it is desired to store data representing a 3D object within one or more computing platforms 101-104. Also, it is desired to transmit (send and receive) data representing 3D objects between the computing platforms 101-104 such as over a local network 112 or a wide area network 113. The networks 112,113 may take any suitable form and may include wired and/or wireless communications as will be familiar to those skilled in the art. In each case it is desired that the object data be relatively compact, whilst still providing a full and detailed representation of a 3D object.

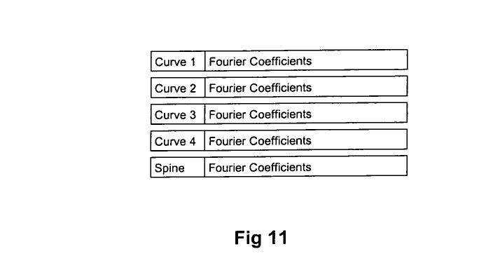

FIG. 11 shows an example data storage format to represent a 3D object as employed in preferred embodiments of the present invention. The data storage format in this example defines the control curves 1-4 (P₁, P₂ and d₁, d₂) in terms of their Fourier coefficients. However, any suitable notation can be used to describe each of the curves.

Also, in the embodiment of FIG. 11, the data storage format includes a definition of the spine as a curve. Again in this example the spine is represented in terms of Fourier coefficients or other suitable curve data format.

By sending just the control curves and optionally the spine, the data storage format is very compact. However, a recipient is immediately able to recreate the PDE surface patch exactly and confidently from the described curves as boundary conditions to the chosen partial differential equation.

As an example, the aircraft shape of FIG. 5b takes about 485 KB when completed geometric information is stored. By contrast, the corresponding boundary curve information requires only about 10 KB of data space. Hence a very significant compression of data is achieved.

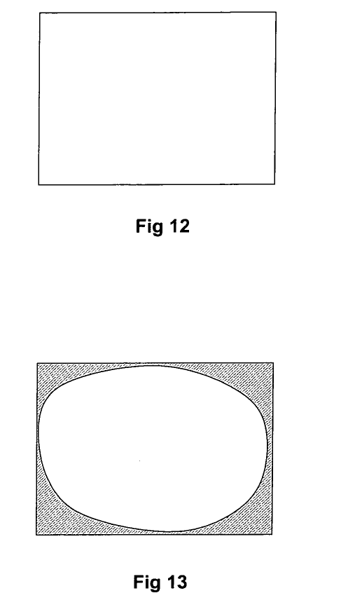

FIGS. 12 to 14 illustrate a further example of the preferred data storage format.

FIG. 12 shows an example curve which here is in the shape of a rectangle. This curve can be written in terms of an infinite Fourier series as:

$${C}_{1} = {\sum }_{n = 1}^{∞} [ {A}_{n} cos ( nv ) + {B}_{n} sin ( nv ) ] \qquad ( 12 )$$

Since the series in Equation (12) is infinite, it is not practical to store this data on a computer platform. To overcome this problem, a finite Fourier analysis of the curve is performed to obtain a close approximation of the curve as shown in FIG. 13. This curve is then represented as:

$${C}_{2} = {\sum }_{n = 1}^{M} [ {A}_{n} cos ( nv ) + {B}_{n} sin ( nv ) ] \qquad ( 13 )$$

where M is a finite number, typically taken to be 10.

Next the difference between the original curve shown in FIG. 12 and the finite Fourier series curve shown in FIG. 13 is computed to represent the original curve as:

$$C = {\sum }_{n = 1}^{M} [ {A}_{n} cos ( nv ) + {B}_{n} sin ( nv ) ] + \underline{R} \qquad ( 14 )$$

where R represents a vector corresponding to the difference between the original curve (FIG. 12) and the finite Fourier series curve (FIG. 13). The vector R is shown by the shaded area in FIG. 13.

Thus, the preferred method enables convenient storage of the data of any curve in terms of a finite Fourier series and a difference vector R.

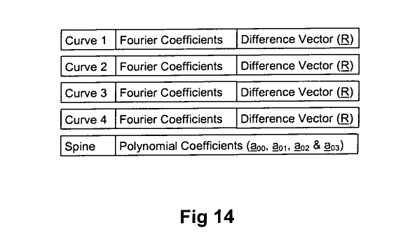

FIG. 14 shows a second preferred data storage arrangement, where each of the boundary curves is stored as a finite Fourier series and a difference vector R. Further, the spine S in the preferred embodiment is given by the polynomial equation:
S=a₀₀+a₀₁u+a₀₂u²+a₀₃u³, (15)

As shown in FIG. 14, the spine is preferably stored simply by storing the four polynomial coefficients a₀₀, a₀₁, a₀₂ and a₀₃.

Although a few preferred embodiments have been shown and described, it will be appreciated by those skilled in the art that various changes and modifications might be made without departing from the scope of the invention, as defined in the appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

I claim:

1. A method to represent a 3D object, comprising the steps of:
providing a plurality of control curves as boundary conditions to a partial differential equation, such that solving the partial differential equation with respect to the boundary conditions provides a surface patch of a 3D object; and
providing a spine associated with the plurality of control curves, such that manipulation of the spine causes coordinated manipulation of the plurality of control curves.

2. The method of claim 1, further comprising:
manipulating the spine, and in response adjusting a position and/or shape of the plurality of control curves to maintain a predetermined association with the spine; and
updating the surface patch of the 3D object according to the adjusted plurality of control curves.

3. The method of claim 1, further comprising:
receiving a user input to manipulate the spine;
automatically adjusting the plurality of control curves in response to the received user manipulation of the spine; and
solving the partial differential equation according to boundary conditions of the adjusted plurality of control curves to provide an updated surface patch of the 3D object.

4. The method of claim 1, wherein
the partial differential equation is of the form
$${( \frac{{\partial }^{2}}{\partial {u}^{2}} + {a}^{2} \frac{{\partial }^{2}}{\partial {v}^{2}} )}^{2} \underline{X} ( u , v ) = 0.$$
where u and v are parameters of the surface patch; and
solving the partial differential equation provides the surface patch comprising surface points each as a sum of a vector A₀ giving a point on the spine, and a radius vector giving a surface point relative to the point on the spine.

5. The method of claim 4, wherein for each point on the surface patch the term
$${\sum }_{n = 1}^{∞} [ {\underline{A}}_{n} ( u ) cos ( nv ) + {\underline{B}}_{n} ( u ) sin ( nv ) ]$$
describes a radial position of the point away from a point at A₀ on the spine.

6. The method of claim 4, wherein the plurality of control curves include at least two position curves P₁ and P₂ which correspond to boundary conditions on the function X (u,v), where P₁(v)=X(0,v) and P₂(v)=X(1,v), and a vector field corresponding to the difference between the position curves P₁ and P₂ and respective difference curves d₁ and d₂, corresponds to the conditions on the function ∂X/∂n such that ∂X/∂n=[p(v)−d(v)]s, where s is a scalar.

7. The method of claim 1, further comprising the step of displaying the spine and the plurality of control curves.

8. The method of claim 1, further comprising the step of displaying the surface patch.

9. The method of claim 8, further comprising storing the surface patch as a set of surface points, and rendering the surface patch on a user display screen using the stored set of surface points.

10. The method of claim 1, comprising the steps of:
describing the spine as a Hermite curve of the form
H(u)=B₁(u)p₁+B₂(u)p₂+B₃(u)v₁+B₄(u)v₂
where the Bᵢ are Hermite basis functions, and the vectors p₁, and v₁,v₂ define a position and speed of the Hermite curve at u=0 and u=1 respectively; and
changing the spine by manipulating its position vectors p₁, p₂ at the two end points thereof and/or its respective speed vectors v₁,v₂.

11. A method to represent a 3D object, comprising the steps of:
providing a set of control curves as initial boundary conditions of a partial differential equation for a surface patch of a 3D object;
solving the partial differential equation according to the set of control curves to derive a spine associated with the set of control curves through the partial differential equation;
manipulating the spine and updating the set of control curves with respect to the spine, thereby providing an updated set of boundary conditions; and
solving the partial differential equation with respect to the updated set of boundary conditions to provide a surface patch of the 3D object.

12. The method of claim 11, wherein the manipulating step comprises:
manipulating the spine, and in response adjusting a position and/or shape of the set of control curves to maintain a predetermined association with the spine.

13. The method of claim 11, wherein the manipulating step further comprises:
receiving a user input to manipulate the spine; and
automatically adjusting the plurality of control curves in response to the received user manipulation of the spine.

14. The method of claim 11, wherein
the partial differential equation is of the form
$${( \frac{{\partial }^{2}}{\partial {u}^{2}} + {a}^{2} \frac{{\partial }^{2}}{\partial {v}^{2}} )}^{2} \underline{X} ( u , v ) = 0.$$
where u and v are parameters of the surface patch;
the plurality of control curves include at least two position curves P₁ and P₂ which correspond to boundary conditions on the function X(u,v), where P₁(v)=X(0,v) and P₂(v)=X(1,v), and respective difference curves d₁ and d₂; and
the spine is given by the term A₀(u) derived by solving the partial differential equation in the form:
$$\underline{X} ( u , v ) = {\underline{A}}_{0} ( u ) + {\sum }_{n = 1}^{∞} [ {\underline{A}}_{n} ( u ) cos ( nv ) + {\underline{B}}_{n} ( u ) sin ( nv ) ] , \\ where$$
$${\underline{A}}_{0} ( u ) = {\underline{a}}_{00} + {\underline{a}}_{01} u + {\underline{a}}_{02} {u}^{2} + {\underline{a}}_{03} {u}^{3} , \\ {\underline{A}}_{n} ( u ) = {\underline{a}}_{n 1} {ⅇ}^{anu} + {\underline{a}}_{n 2} u {ⅇ}^{anu} + {\underline{a}}_{n 3} {ⅇ}^{- anu} + {\underline{a}}_{n 4} u {ⅇ}^{- anu} , \\ {\underline{B}}_{n} ( u ) = {\underline{b}}_{n 1} {ⅇ}^{anu} + {\underline{b}}_{n 2} u {ⅇ}^{anu} + {\underline{b}}_{n 3} {ⅇ}^{- anu} + {\underline{b}}_{n 4} u {ⅇ}^{- anu} ,$$
where a₀₀,a₀₁,a₀₂,a₀₃,aₙ₁,aₙ₂,aₙ₃,aₙ₄,bₙ₁,bₙ₂,bₙ₃ and bₙ₄ are vector constants, whose values are determined by the boundary conditions at u=0 and u=1.

15. The method of claim 14, wherein the solving step comprises solving the partial differential equation with respect to the updated boundary conditions imposed by manipulating the spine, to thereby present an updated surface patch of the 3D object.

16. The method of claim 14, comprising the steps of:
describing the spine as a Hermite curve of the form:
H(u)=B₁(u)p₁+B₂(u)p₂+B₃(u)v₁+B₄(u)v₂
where Bᵢ are Hermite basis functions, and vectors p₁, p₂ and v₁,v₂ define a position and speed of the Hermite curve at u=0 and u=1 respectively; and
changing the spine by manipulating position vectors p₁, p₂ at two end points thereof and/or respective speed vectors v₁,v₂ for each of the end points.

17. The method of claim 11, wherein the step of solving the partial differential equation provides the surface patch comprising surface points each as a sum of a vector A₀ giving a point on the spine, and a radius vector giving a surface point relative to the point on the spine.

18. The method of claim 11, further comprising the step of storing the surface patch as a set of the surface points, and rendering the surface patch on a user display screen using the stored set of surface points.

19. A computer-aided design tool, comprising:
a display unit to display images to a user;
an input unit to receive user manipulation commands from the user; and
a processor to perform the steps of:
providing a plurality of control curves as boundary conditions to a partial differential equation, such that solving the partial differential equation with respect to the boundary conditions provides a surface patch of a 3D object; and
providing a spine associated with the plurality of control curves, such that manipulation of the spine according to the user manipulation commands received by the input unit causes coordinated manipulation of the plurality of control curves.

20. A computer graphics apparatus arranged to perform the steps of:
providing a set of control curves as initial boundary conditions of a partial differential equation for a surface patch of a 3D object;
solving the partial differential equation according to the set of control curves to derive a spine associated with the set of control curves through the partial differential equation;
manipulating the spine and updating the set of control curves with respect to the spine, thereby providing an updated set of boundary conditions; and
solving the partial differential equation with respect to the updated set of boundary conditions to provide a surface patch of the 3D object.
